(19) United States
(12) Patent Application Publication
(10) Pub. No.: US 2026/0038176 A1
(43) Pub. Date: Feb. 5, 2026

(54) SELF-ADAPTIVE MOTION ARTIFACT DETECTION METHOD AND THREE-DIMENSIONAL RECONSTRUCTION METHOD USING THE SAME

(71) Applicant: ZHEJIANG HEHU TECHNOLOGY CO., LTD., HANGZHOU (CN)

(72) Inventor: YI YANG, HANGZHOU (CN)

(21) Appl. No.: 19/286,969

(22) Filed: Jul. 31, 2025

(30) Foreign Application Priority Data
Jul. 31, 2024 (CN) 202411036847.5

(51) Int. Cl. G06T 11/00; G06T 3/02; G06T 5/70; G06T 7/11; G06T 7/20; G06T 15/00

(52) U.S. Cl. CPC G06T 11/008; G06T 3/02; G06T 5/70; G06T 7/11; G06T 7/20; G06T 15/00

(57) ABSTRACT

A self-adaptive motion artifact detection method, and a three-dimensional reconstruction method using the same are provided. The self-adaptive motion artifact detection method includes: acquiring a multi-view rearranged image, decoupling the multi-view rearranged image to obtain a scanning sub-image sequence; dividing each scanning sub-image in the scanning sub-image sequence into blocks; and determining a reference scanning sub-image, and sequentially performing motion artifact detection on individual sub-blocks in the reference scanning sub-image and the sub-blocks in the remaining scanning sub-images.

### CROSS REFERENCE TO RELATED APPLICATIONS

The present disclosure claims the priority to the Chinese patent application with the filing No. 202411036847.5, entitled “SELF-ADAPTIVE MOTION ARTIFACT DETECTION METHOD AND THREE-DIMENSIONAL RECONSTRUCTION METHOD USING THE SAME” and filed on Jul. 31, 2024 with the Chinese Patent Office, the contents of which are incorporated herein by reference in their entirety.

### TECHNICAL FIELD

The present disclosure relates to the technical field of image processing, and more particularly to a self-adaptive motion artifact detection method and a three-dimensional reconstruction method using the same.

### BACKGROUND ART

In the field of optical imaging, two-dimensional imaging technology has always played a vital role. However, due to the limitations of camera pixel resolution and optical system aberrations, traditional two-dimensional imaging methods have difficulty in achieving higher resolutions. In recent years, meta-imaging technology has attracted much attention in the field of optical researches due to its unique multi-angle image acquisition method. Unlike traditional two-dimensional imaging, the meta-imaging technology can not only acquire spatial information, but also capture angle information, and thus actually contains four-dimensional information content.

As a branch of meta-imaging technology, light field imaging technology can record the four-dimensional light field information of the system and reconstruct the three-dimensional shape of the shot target based on the information. Based on light field imaging, researchers further proposed a scanning light field system. This system introduces high-frequency predetermined trajectory scanning at the sub-pixel level, and generates an ultra-high-resolution light field image by synthesizing multiple scanned images, thereby significantly improving the spatial resolution of light field imaging.

However, the introduction of the scanning mode also brings a problem: when shooting a dynamic object, the movement of the shot object may cause the relative displacement of the image shot at each scanning point to exceed the scanning sub-pixel interval, thereby generating motion artifacts in the high-resolution scanning light field image, which in turn affects the subsequent 3D reconstruction process. Therefore, the detection of motion artifacts is crucial for the subsequent removal of motion artifacts and three-dimensional reconstruction.

However, when actually shooting a moving sample, factors such as fluorescence quenching, system noise, and background contamination may be coupled with various unpredictable motion patterns, causing some movements of the sample to be difficult to detect. The ignored sample spatiotemporal motion artifacts will be highlighted in the subsequent three-dimensional reconstruction process, affecting the final imaging quality.

Meanwhile, for samples with different motion modes, the existing scanning light field system requires manual intervention to start the motion artifact removal method, which not only interrupts the integrity of the processing flow and makes it impossible to unifiedly process samples of the modes end to end, but also results in difficult human judgment, low efficiency and poor detection stability due to the above coupling problem.

### SUMMARY

In order to solve these problems, the present disclosure provides a self-adaptive motion artifact detection method based on multi-view scanning light field images. This method can replace human judgment, reduce labor costs, and improve detection efficiency. In addition, this method can be used as a front-end detection module of the motion artifact removal method in various scanning light field systems, improve the compactness of the scanning light field system, and realize an end-to-end scanning light field image processing process without manual intervention.

In order to achieve the above object, the present disclosure adopts the following technical solutions.

A self-adaptive motion artifact detection method includes:
S1. acquiring a multi-view rearranged image, and decoupling the multi-view rearranged image to obtain a scanning sub-image sequence;
S2, dividing each scanning sub-image in the scanning sub-image sequence into blocks; and
S3, determining a reference scanning sub-image, and sequentially performing motion artifact detection on individual sub-blocks in the reference scanning sub-image and the sub-blocks in the remaining scanning sub-images.

Preferably, before the decoupling, the multi-view rearranged image is subjected to denoising which includes:
reducing Gaussian noise through multi-view averaging, and
reducing background noise by subtracting a fixed value of background noise intensity.

Preferably, in step S1, the scanning sub-image sequence is s*h*w, where s indicates the total number of scanning sub-images, h and w indicate the pixel height and width of each scanning sub-image respectively, and numerically, h=H/\sqrt{s}, and w=W/\sqrt{s}.

Preferably, in step S1, motion compensation is performed after obtaining the scanning sub-images, including determining the coordinate offset of each scanning point in the scanning sub-images relative to the central scanning point, and performing affine transformation according to the coordinate offset, where the expression is:

$${I}_{transed} = warpAffine ( {I}_{scan} , [ \begin{matrix}1 & 0 & {Δ}_{h} \\ 0 & 1 & {Δ}_{w}\end{matrix} ] )$$

In the expression, I_{transed} represents the scanning sub-image sequence after motion compensation, Δₕ and Δ_{w} indicate the offsets of the scanning point in the column direction and the row direction relative to the central scanning point respectively, warpAffine indicates the affine transformation operation, and I_{scan} indicates the scanning sub-image sequence.

Preferably, in S3, the sequentially performing motion artifact detection on individual sub-blocks in the reference scanning sub-image and the sub-blocks in the remaining scanning sub-images includes:
S31, traversing, according to the j-th sub-block in the reference scanning sub-image, the sub-blocks with the same serial number j in the remaining s−1 scanning sub-images, where s indicates the total number of scanning sub-images;
S32, acquiring an energy difference map between the j-th sub-block in the reference scanning sub-image and the j-th sub-block in each scanning sub-image;
S33, obtaining a motion artifact detection result of the j-th sub-block in each scanning sub-image relative to the j-th sub-block in the reference scanning sub-image based on the energy difference map; and
S34, letting j=j+1, and repeatedly executing steps S31-S33 until all sub-blocks in the scanning sub-image are traversed.

Preferably, in S33, the obtaining a motion artifact detection result of the j-th sub-block in each scanning sub-image relative to the j-th sub-block in the reference scanning sub-image based on the energy difference map includes:
determining the maximum value of the energy difference map, and determining, according to the spatial coordinates of the maximum value, the first pixel value of the maximum value of the energy difference map in the j-th sub-block of the reference scanning sub-image and the second pixel value of the maximum value of the energy difference map in the j-th sub-block of the corresponding scanning sub-image; and performing motion artifact detection based on the maximum value of the energy difference map, the first pixel value and the second pixel value as follows:

$${motion}_{s} = ( {diff}_{max} / {E}_{1} ) > σ ‖ ( {diff}_{max} / {E}_{2} ) > σ )$$

in the above, motionₛ represents the detection result, diffₘₐₓ represents the maximum value of the energy difference map, E₁ represents the first pixel value, E₂ represents the second pixel value, ∥ represents the OR logical operation, and σ represents the preset threshold.

Preferably, in S33, the obtaining a motion artifact detection result of the j-th sub-block in each scanning sub-image relative to the j-th sub-block in the reference scanning sub-image based on the energy difference map includes:
determining the maximum value of the energy difference map, and determining, according to the spatial coordinates of the maximum value, the first pixel value of the maximum value of the energy difference map in the j-th sub-block of the reference scanning sub-image and the second pixel value of the maximum value of the energy difference map in the j-th sub-block of the corresponding scanning sub-image; and performing motion artifact detection based on the maximum value of the energy difference map, the first pixel value and the second pixel value as follows:

$${motion}_{s} = ( ( {diff}_{max} / {E}_{1} ) > σ ‖ ( {diff}_{max} / {E}_{2} ) > σ ) \&\& ( ( {E}_{1} / {E}_{{signal}_{1}} ) > σ ‖ ( {E}_{2} / {E}_{{signal}_{2}} ) > σ )$$

in the above, motionₛ represents the detection result, diffₘₐₓ represents the maximum value of the energy difference map, E₁ represents the first pixel value, E₂ represents the second pixel value, ∥ represents the OR logical operation, && represents the AND logical operation, σ represents the preset threshold, and E_{signal} represents the foreground energy.

Preferably, in S3, a three-dimensional matrix is generated according to the motion artifact detection results of individual sub-blocks in the reference scanning sub-image and the sub-blocks in the remaining scanning sub-images, and the motion artifact detection results of the multi-view rearranged image are output according to the three-dimensional matrix.

The present disclosure further provides a three-dimensional reconstruction method, including:
acquiring light field microscopy data;
rearranging the light field data to obtain a multi-view rearranged image;
performing motion artifact detection on the multi-view rearranged image using the self-adaptive motion artifact detection method as described in any one of the above, and
performing, if there are motion artifacts, three-dimensional reconstruction after removing the motion artifacts, otherwise, directly performing three-dimensional reconstruction based on the multi-view rearranged image.

It can be seen from the above technical solutions that the present disclosure discloses a self-adaptive motion artifact detection method and a three-dimensional reconstruction method using the same. Compared with the prior art, the present application utilizes the four-dimensional information of the scanned light field image to perform fast and accurate automatic motion detection on the noisy image, which, compared with manual judgment and manual intervention in the subsequent processing algorithm, can not only improve the detection accuracy and efficiency of motion artifacts, but also improve the compactness and integrity of the scanning light field image processing flow, thereby realizing true end-to-end processing.

### BRIEF DESCRIPTION OF DRAWINGS

In order to more clearly illustrate the technical solutions in the embodiments of the present disclosure or in the prior art, the drawings required to be used in the description of the embodiments or the prior art will be briefly introduced below. Obviously, the drawings described below are only embodiments of the present disclosure. For a person skilled ordinarily in the art, other drawings can be obtained based on the provided drawings without paying creative work.

FIG. 1 is a flowchart of a self-adaptive motion artifact detection method provided by the present disclosure; and

FIG. 2 is a flowchart example of a self-adaptive motion artifact detection method provided by the present disclosure.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only some of the embodiments of the present disclosure, not all of the embodiments. Based on the embodiments of the present disclosure, all other embodiments obtained by a person skilled ordinarily in the art without creative work fall within the scope of protection of the present disclosure.

The scanning light field system may greatly improve the spatial resolution of light field data in static scenes, but when shooting dynamic scenes, may inevitably have motion artifacts due to the scanning characteristics, which may make the advantages of the scanning mode disappear. Moreover, the motion artifacts may affect the subsequent reconstruction process. Therefore, efficient and accurate detection of the motion of the shot sample is crucial for subsequent motion artifact removal and three-dimensional reconstruction.

In view of this, the present disclosure discloses a self-adaptive motion artifact detection method and a three-dimensional reconstruction method using the same. The implementation process is described below through embodiments.

### Embodiment 1

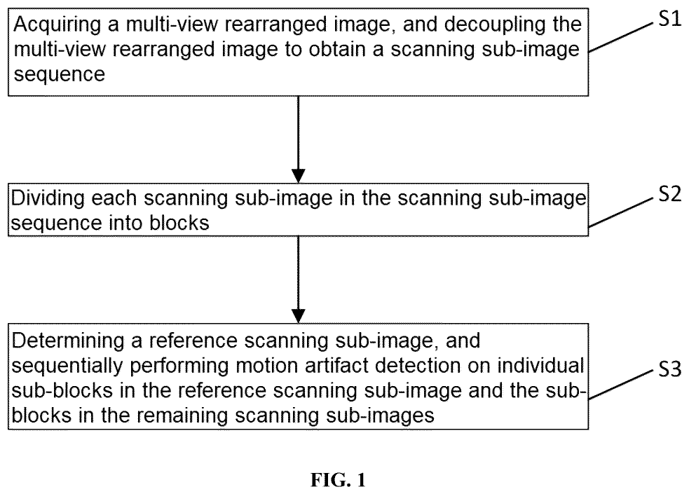

This embodiment discloses a self-adaptive motion artifact detection method, as shown in FIG. 1, which mainly includes the following steps:
S1. acquiring a multi-view rearranged image, and decoupling the multi-view rearranged image to obtain a scanning sub-image sequence;
S2, dividing each scanning sub-image in the scanning sub-image sequence into blocks; and
S3, determining a reference scanning sub-image, and sequentially performing motion artifact detection on individual sub-blocks in the reference scanning sub-image and the sub-blocks in the remaining scanning sub-images.

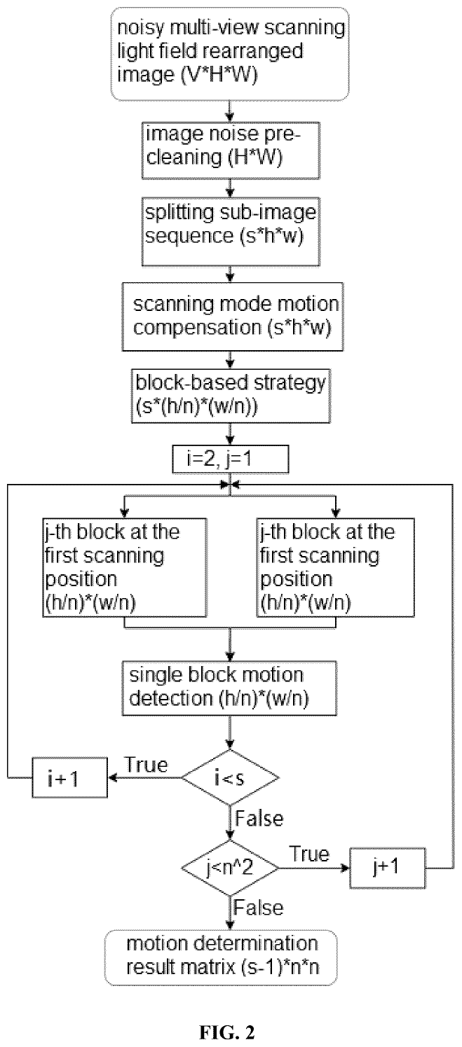

In an exemplary embodiment, as shown in FIG. 2, step S1 includes:
S11, preferentially performing noise pre-cleaning after acquiring the multi-view rearranged image.

Generally, the main components of noise of the scanning light field system are mainly Gaussian noise and background noise. In order to prevent these two kinds of noise from affecting the subsequent motion artifact detection algorithm, noise pre-cleaning requires to be performed first. In the above, the pre-cleaning includes reducing the Gaussian noise by multi-view averaging, and reducing the background noise by subtracting a fixed value of background noise intensity.

Since the Gaussian noise belongs to random noise, it conforms to the independent and identically distributed assumption in different views of the scanning light field image, and thus, the multi-view averaging operation may be used to reduce the influence of the Gaussian noise and enhance the signal. Taking a multi-view rearranged image Iₙₒᵢₛₑ with a shape of V*H*W as an example, the view averaging operation may be expressed as follows:

$${I}_{noise}^{′} = ( {\sum }_{v = 1}^{V} {I}_{noise} ) / V$$

in the above,

$${I}_{noise}^{′}$$

represents the rearranged image after the view averaging, and has a shape of H*W.

For the background noise, its influence on the subsequent motion artifact judgment algorithm may be weakened by directly subtracting a fixed value of the background noise intensity.

In one embodiment, the background noise is removed on the basis of reducing the Gaussian noise; that is, after the view averaging, the influence of the Gaussian noise on the image is weakened, and the remaining background noise is a composite noise with an intensity distribution near the fixed value, so the background noise is further removed according to the following formula:

$${I}_{clean} = {I}_{noise}^{′} - o$$

in the above, σ represents the system background noise intensity value, and I_{clean} represents the rearranged image after subtracting the background noise, and has a shape of H*W.

S12, decoupling the multi-view rearranged image to obtain a scanning sub-image sequence.

In this embodiment, the rearranged image of the scanning light field system is formed by splicing individual scanning sub-images in one scanning cycle according to the spatial scanning trajectory. The subsequent judgment algorithm is performed on each sub-image in the one scanning cycle. Therefore, the noise-free image I_{clean} obtained in the previous step is first decoupled into a scanning sub-image sequence I_{scan} with a shape of s*h*w according to the scanning mode, where s indicates the total number of scanning sub-images, which is the number of scanning points in one scanning cycle in practice, and h and w indicate the pixel height and width of each scanning sub-image, and in terms of numerical value, h=H/\sqrt{s}, w=W/\sqrt{s}.

In a preferred embodiment, it further includes:
S13, performing motion compensation after obtaining the scanning sub-images.

Due to the scanning characteristics of the scanning light field system, each scanning sub-image may have a spatial sub-pixel offset, which is visually manifested as the relative jitter of the entire image when the scanning sub-images are observed continuously. In order to prevent the subsequent motion detection algorithm from mistaking this jitter for the movement of the sample in the image, the motion compensation of the scanning mode is required to be performed to eliminate the jitter between the scanning sub-images.

The compensation method includes determining the coordinate offset of each scanning point in the scanning sub-image relative to the central scanning point. In order to eliminate the offset, affine transformation is performed on each point sub-image spatially according to the horizontal and vertical coordinate offsets, where the expression is:

$${I}_{transed} = warpAffine ( {I}_{scan} , [ \begin{matrix}1 & 0 & {Δ}_{h} \\ 0 & 1 & {Δ}_{w}\end{matrix} ] )$$

In the expression, I_{transed} represents the scanning sub-image sequence after motion compensation, Δₕ and Δ_{w} indicate the offsets of the scanning point in the column direction and row direction relative to the central scanning point, warpAffine indicates the affine transformation operation, and I_{scan} indicates the scanning sub-image sequence.

In the present disclosure, in S2, each scanning sub-image in the scanning sub-image sequence is divided into blocks.

Since some samples may have the case in which only a small part of the structure moves and the rest is still, in order to prevent the small movement from being submerged in the overall stillness, a block-based motion judgment strategy is set. Therefore, each scanning sub-image of I_{transed} with a shape of h*w is firstly divided spatially into n*n sub-blocks Isub, and then the operation in step S3 is performed on each block in turn.

Further, step S3 includes:
determining a reference scanning sub-image, and sequentially performing motion artifact detection on individual sub-blocks in the reference scanning sub-image and the sub-blocks in the remaining scanning sub-images, where the specific process is as follows:
S31, traversing, according to the j-th sub-block in the reference scanning sub-image, the sub-blocks with the same serial number j in the remaining s−1 scanning sub-images, where s indicates the total number of scanning sub-images;
S32, acquiring an energy difference map between the j-th sub-block in the reference scanning sub-image and the j-th sub-block in each scanning sub-image, where the energy difference map is the absolute value of the energy difference between the two sub-blocks;
S33, obtaining a motion artifact detection result of the j-th sub-block in each scanning sub-image relative to the j-th sub-block in the reference scanning sub-image based on the energy difference map, which process includes:
determining the maximum value of the energy difference map, and determining, according to the spatial coordinates of the maximum value, the first pixel value of the maximum value of the energy difference map in the j-th sub-block of the reference scanning sub-image and the second pixel value of the maximum value of the energy difference map in the j-th sub-block of the corresponding scanning sub-image; and
performing motion artifact detection based on the maximum value of the energy difference map, the first pixel value and the second pixel value as follows;

$${motion}_{s} = ( {diff}_{max} / {E}_{1} ) > σ ‖ ( {diff}_{max} / {E}_{2} ) > σ )$$

in the above, motionₛ represents the detection result, diffₘₐₓ represents the maximum value of the energy difference map, E₁ represents the first pixel value, E₂ represents the second pixel value, ∥ represents the OR logical operation, and σ represents the preset threshold.

Taking the first scanning sub-image as the reference scanning sub-image and the first sub-block I_{sub1} therein as an example for description, at this time, all the first sub-blocks in the remaining s−1 scanning sub-images are required to be traversed, and then the absolute values of the pixel value differences between them and the first sub-block in the reference scanning sub-image are calculated respectively to obtain the energy difference map diff corresponding to the sub-block I_{sub1} and the first sub-block I_{subi} of each scanning sub-image, where s indicates the total number of scanning sub-images.

When determining the motion artifact situation of the first sub-block in the scanning sub-image relative to the first sub-block in the reference scanning sub-image, first the maximum value diffₘₐₓ in the energy difference map and the spatial coordinate position of the maximum value are found, and the first pixel value E₁ of the spatial coordinate position in the first sub-block of the reference scanning sub-image, and the second pixel value E₂ thereof in the first sub-block of the scanning sub-image corresponding to the energy difference map are determined respectively.

Based on the priori knowledge that sample motion is the movement of pixel position on an image, the ratios of diffₘₐₓ to E₁ and to E₂ are calculated using the above formula respectively. The degree of change in pixel values may be used to determine whether there is motion in the first sub-blocks of the reference scanning sub-image and the scanning sub-image corresponding to the energy difference map.

In an optional embodiment, when most of the sub-block is background and the pixel intensity is very low, a slight intensity change may cause a large change in the ratios of diffₘₐₓ to E₁ and to E₂, thereby causing the background fluctuation to be identified as sample motion.

Therefore, this embodiment proposes to add background elimination judgment on the basis of the above judgment conditions. This judgment may be performed by calculating the ratios of E₁ to E_{signal1} and E₂ to E_{signal2}. If the ratio is higher than the set threshold, it may be considered that the changed point is the foreground rather than the background. If the above two judgment conditions are met at the same time, it may be considered that the reference scanning sub-image and the scanning sub-image corresponding to the maximum value in the energy difference map have motion in the sub-block and the moving point is the foreground target rather than the background.

At this point, the detection process includes:
determining the first pixel value of the spatial position of the maximum value of the energy difference map in the j-th sub-block of the reference scanning sub-image and the second pixel value in the j-th sub-block of the scanning sub-image corresponding to the energy difference map respectively, and performing motion artifact detection based on the first pixel value and the second pixel value as follows;

$${motion}_{s} = ( ( {diff}_{max} / {E}_{1} ) > σ ‖ ( {diff}_{max} / {E}_{2} ) > σ ) \&\& ( ( {E}_{1} / {E}_{{signal}_{1}} ) > σ ‖ ( {E}_{2} / {E}_{{signal}_{2}} ) > σ )$$

in the above, motionₛ represents the detection result (1 indicates that there are motion artifacts, and 0 indicates that there are no motion artifacts), diffₘₐₓ represents the maximum value of the energy difference map, E₁ represents the first pixel value, E₂ represents the second pixel value, ∥ represents the OR logical operation, && represents the AND logical operation, σ represents the preset threshold, E_{signal1} represents the foreground energy of the reference scanning sub-image, and E_{signal1} represents the foreground energy of the scanning sub-image corresponding to the maximum value, where the foreground energy is the average of the top 50 pixel values of each scanning sub-image.
S34, letting j=j+1, and repeatedly executing steps S31-S33 until all sub-blocks in the scanning sub-image are traversed.

In this embodiment, the traversal process is implemented with reference to FIG. 2, and is specifically as follows:
letting i=2, and j=1, where i indicates the serial number of the scanning sub-image, the first scanning sub-image (i=1) is the reference scanning sub-image, and j is the serial number of the sub-block in the reference scanning sub-image;
sequentially performing single block motion detection on the j-th block at the first scanning position and the j-th block at the i-th scanning position, and
after the detection is completed, if i<s, letting i+1 return to continue execution; otherwise, determining if j<n², and returning, if j<n², to continue to determine the j+1-th sub-block, otherwise, outputting the motion determination result matrix.

In this embodiment, each time steps S31-S33 are executed, the motion situation between two scanning sub-images of a certain sub-block may be obtained. When all sub-blocks in the scanning sub-image are traversed, a three-dimensional matrix with a shape of (s−1)*n*n may be obtained, and the values in the matrix are 0 or 1. Through this matrix, the detailed motion artifact detection result of the detected multi-view scanning light field image may be obtained.

### Embodiment 2

This embodiment discloses a three-dimensional reconstruction method, including steps:
acquiring light field microscopy data, that is, obtaining light field microscopy data containing four-dimensional information by a scanning light field microscopy system;
rearranging the light field data to obtain a multi-view rearranged image, where in this embodiment, the light field data obtained in the previous step is rearranged to obtain the multi-view rearranged image with a shape of V*H*W, where V indicates the number of viewing angles of the rearranged image, H indicates the pixel height of the rearranged image, and W indicates the pixel width of the rearranged image; and
performing motion artifact detection on the multi-view rearranged image by using the above-mentioned self-adaptive motion artifact detection method, where specifically, the multi-view rearranged image obtained in the previous step is sent to the motion artifact detection program to determine whether there are motion artifacts in the image,
where if there are motion artifacts in the detection result of the previous step, firstly the motion artifacts in the corresponding rearranged image are removed through a motion artifact removal network, and then the rearranged image after the motion artifacts are removed is sent to the reconstruction algorithm for three-dimensional reconstruction, and if there are no motion artifacts in the detection result of the previous step, the rearranged image is directly sent to the reconstruction algorithm for three-dimensional reconstruction. It should be noted that the present application does not limit the motion artifact removal network, and any application of a network that can realize the artifact removal function falls within the protection scope of the present application.

The present disclosure innovatively utilizes the four-dimensional information of the scanning light field image to perform fast and accurate automatic motion detection on the noisy image. Compared with manual judgment and manual intervention in the subsequent processing algorithm, the present disclosure can improve the compactness and integrity of the scanning light field image processing flow and realize true end-to-end processing.

In this specification, the embodiments are described in a progressive manner, and each embodiment focuses on the differences from other embodiments. The same or similar parts between the embodiments may be referred to each other. For the device disclosed in the embodiment, since it corresponds to the method disclosed in the embodiment, the description is relatively simple, and the relevant parts may be referred to the method parts.

The above description of the disclosed embodiments enables one skilled in the art to implement or use the present application. Various modifications to these embodiments will be obvious to one skilled in the art, and the general principles defined herein may be implemented in other embodiments without departing from the spirit or scope of the present disclosure. Therefore, the present application will not be limited to the embodiments shown herein, but rather will conform to the widest scope consistent with the principles and novel features disclosed herein.

1. A self-adaptive motion artifact detection method, comprising:
S1, acquiring a multi-view rearranged image, and decoupling the multi-view rearranged image to obtain a scanning sub-image sequence; and
S2, dividing each of scanning sub-images in the scanning sub-image sequence into blocks;
S3, determining a reference scanning sub-image, and sequentially performing motion artifact detection on individual sub-blocks in the reference scanning sub-image and sub-blocks in remaining scanning sub-images, including:
S31, traversing, according to a j-th sub-block in the reference scanning sub-image, sub-blocks with a same serial number j in the remaining s−1 scanning sub-images;
S32, acquiring an energy difference map between the j-th sub-block in the reference scanning sub-image and the j-th sub-block in each scanning sub-image; and
S33, obtaining a motion artifact detection result of the j-th sub-block in the each scanning sub-image relative to the j-th sub-block of the reference scanning sub-image based on the energy difference map, including:
determining a maximum value of the energy difference map, and determining, according to spatial coordinates of the maximum value, a first pixel value of the maximum value of the energy difference map in the j-th sub-block of the reference scanning sub-image, and a second pixel value of the maximum value of the energy difference map in the j-th sub-block of a corresponding scanning sub-image; and
performing motion artifact detection as follows, based on the maximum value of the energy difference map, the first pixel value and the second pixel value:
$${motion}_{s} = ( {diff}_{max} / {E}_{1} ) > σ ‖ ( {diff}_{max} / {E}_{2} ) > σ )$$
wherein motionₛ represents the detection result, diffₘₐₓ represents the maximum value of the energy difference map, E₁ represents the first pixel value, E₂ represents the second pixel value, ∥ represents a OR logical operation, and σ represents a preset threshold.

2. The self-adaptive motion artifact detection method according to claim 1, wherein before the decoupling, the multi-view rearranged image is subjected to denoising, which comprises:
reducing Gaussian noise through multi-view averaging, and
reducing background noise by subtracting a fixed value of background noise intensity.

3. The self-adaptive motion artifact detection method according to claim 1, wherein in step S1, the scanning sub-image sequence is s*h*w, wherein s indicates a total number of the scanning sub-images, h and w indicate pixel height and width of each scanning sub-image respectively, and numerically, h=H/\sqrt{s}, and w=W/\sqrt{s}.

4. The self-adaptive motion artifact detection method according to claim 1, wherein in step S1, after obtaining the scanning sub-images, motion compensation is performed, including determining a coordinate offset of each scanning point in the scanning sub-images relative to a central scanning point, and performing affine transformation according to the coordinate offset, wherein an expression is:
$${I}_{transed} = warpAffine ( {I}_{scan} , [ \begin{matrix}1 & 0 & {Δ}_{h} \\ 0 & 1 & {Δ}_{w}\end{matrix} ] )$$
in the expression, I_{transed} represents the scanning sub-image sequence after the motion compensation, Δₕ and Δ_{w} indicate offsets of the scanning point in a column direction and a row direction relative to the central scanning point respectively, warpAffine indicates an affine transformation operation, and I_{scan} indicates the scanning sub-image sequence.

5. The self-adaptive motion artifact detection method according to claim 1, wherein the sequentially performing motion artifact detection on the individual sub-blocks in the reference scanning sub-image and the sub-blocks in the remaining scanning sub-images in S3 comprises:
S34, letting j=j+1, and repeatedly executing steps S31-S33 until all sub-blocks in the scanning sub-image are traversed.

6. The self-adaptive motion artifact detection method according to claim 5, wherein the obtaining the motion artifact detection result of the j-th sub-block in the each scanning sub-image relative to the j-th sub-block of the reference scanning sub-image based on the energy difference map in S33 comprises:
determining the maximum value of the energy difference map, and determining, according to the spatial coordinates of the maximum value, the first pixel value of the maximum value of the energy difference map in the j-th sub-block of the reference scanning sub-image and the second pixel value of the maximum value of the energy difference map in the j-th sub-block of the corresponding scanning sub-image; and performing motion artifact detection as follows, based on the maximum value of the energy difference map, the first pixel value and the second pixel value;
$${motion}_{s} = ( ( {diff}_{max} / {E}_{1} ) > σ ‖ ( {diff}_{max} / {E}_{2} ) > σ ) \&\& ( ( {E}_{1} / {E}_{{signal}_{1}} ) > σ ‖ ( {E}_{2} / {E}_{{signal}_{2}} ) > σ )$$
wherein motionₛ represents the detection result, diffₘₐₓ represents the maximum value of the energy difference map, E₁ represents the first pixel value, E₂ represents the second pixel value, ∥ represents the OR logical operation, && represents an AND logical operation, σ represents the preset threshold, E_{signal} represents foreground energy, E_{signal1} represents foreground energy of the reference scanning sub-image, and E_{signal2} represents foreground energy of the scanning sub-image corresponding to the maximum value.

7. The self-adaptive motion artifact detection method according to claim 1, wherein in S3, a three-dimensional matrix is generated according to the motion artifact detection results of individual sub-blocks in the reference scanning sub-image and the sub-blocks in the remaining scanning sub-images, and the motion artifact detection results of the multi-view rearranged image are output according to the three-dimensional matrix.

8. A three-dimensional reconstruction method, comprising:
acquiring light field microscopy data;
rearranging the light field data to obtain a multi-view rearranged image;
performing motion artifact detection on the multi-view rearranged image by using the self-adaptive motion artifact detection method according to claim 1; and
performing, if there are motion artifacts, three-dimensional reconstruction after removing the motion artifacts, otherwise, directly performing three-dimensional reconstruction based on the multi-view rearranged image.

9. The three-dimensional reconstruction method according to claim 8, wherein before the decoupling, the multi-view rearranged image is subjected to denoising, which comprises:
reducing Gaussian noise through multi-view averaging, and
reducing background noise by subtracting a fixed value of background noise intensity.

10. The three-dimensional reconstruction method according to claim 8, wherein in step S1, the scanning sub-image sequence is s*h*w, wherein s indicates a total number of the scanning sub-images, h and w indicate pixel height and width of each scanning sub-image respectively, and numerically, h=H/\sqrt{s}, and w=W/\sqrt{s}.

11. The three-dimensional reconstruction method according to claim 8, wherein in step S1, after obtaining the scanning sub-images, motion compensation is performed, including determining a coordinate offset of each scanning point in the scanning sub-images relative to a central scanning point, and performing affine transformation according to the coordinate offset, wherein an expression is:
$${I}_{transed} = warpAffine ( {I}_{scan} , [ \begin{matrix}1 & 0 & {Δ}_{h} \\ 0 & 1 & {Δ}_{w}\end{matrix} ] )$$
in the expression, I_{transed} represents the scanning sub-image sequence after the motion compensation, Δₕ and Δ_{w} indicate offsets of the scanning point in a column direction and a row direction relative to the central scanning point respectively, warpAffine indicates an affine transformation operation, and I_{scan} indicates the scanning sub-image sequence.

12. The three-dimensional reconstruction method according to claim 8, wherein the sequentially performing motion artifact detection on the individual sub-blocks in the reference scanning sub-image and the sub-blocks in the remaining scanning sub-images in S3 comprises:
S34, letting j=j+1, and repeatedly executing steps S31-S33 until all sub-blocks in the scanning sub-image are traversed.

13. The three-dimensional reconstruction method according to claim 12, wherein the obtaining the motion artifact detection result of the j-th sub-block in the each scanning sub-image relative to the j-th sub-block of the reference scanning sub-image based on the energy difference map in S33 comprises:
determining the maximum value of the energy difference map, and determining, according to the spatial coordinates of the maximum value, the first pixel value of the maximum value of the energy difference map in the j-th sub-block of the reference scanning sub-image and the second pixel value of the maximum value of the energy difference map in the j-th sub-block of the corresponding scanning sub-image; and performing motion artifact detection as follows, based on the maximum value of the energy difference map, the first pixel value and the second pixel value;
$${motion}_{s} = ( ( {diff}_{max} / {E}_{1} ) > σ ‖ ( {diff}_{max} / {E}_{2} ) > σ ) \&\& ( ( {E}_{1} / {E}_{{signal}_{1}} ) > σ ‖ ( {E}_{2} / {E}_{{signal}_{2}} ) > σ )$$
wherein motionₛ represents the detection result, diffₘₐₓ represents the maximum value of the energy difference map, E₁ represents the first pixel value, E₂ represents the second pixel value, ∥ represents the OR logical operation, && represents an AND logical operation, σ represents the preset threshold, E_{signal} represents foreground energy, E_{signal1} represents foreground energy of the reference scanning sub-image, and E_{signal2} represents foreground energy of the scanning sub-image corresponding to the maximum value.

14. The three-dimensional reconstruction method according to claim 8, wherein in S3, a three-dimensional matrix is generated according to the motion artifact detection results of individual sub-blocks in the reference scanning sub-image and the sub-blocks in the remaining scanning sub-images, and the motion artifact detection results of the multi-view rearranged image are output according to the three-dimensional matrix.
